(19) United States
(12) Patent Application Publication
(10) Pub. No.: US 2015/0000782 A1
(43) Pub. Date: Jan. 1, 2015

(54) POLYVINYL CHLORIDE - COMPOSITION, TUBE, CHANNEL OR CONTAINER, USE OF A PVC COMPOSITION AND USE OF A TUBE, OF A CHANNEL OR OF A CONTAINER

(71) Applicant: George Fischer DEKA GmbH, Dautphetal-Mornshausen (DE)

(72) Inventors: Stephan Schuessler, Caldern (DE); Achim Weiss, Dautphetal-Mornshausen (DE); Gerhard Wewior, Biedenkopf (DE); Florian Giersbach, Eschenburg-Eibelshausen (DE)

(21) Appl. No.: 14/371,104

(22) PCT Filed: Jan. 4, 2013
(86) PCT No.: PCT/EP2013/050081

§ 371 Date: Jul. 8, 2014

(30) Foreign Application Priority Data
Jan. 13, 2012 (EP) 12000194.6

(51) Int. Cl. F16L 9/133; C08K 3/08; C08F 14/06

(52) U.S. Cl. CPC F16L 9/133; C08F 14/06; C08K 3/08
USPC 138/141; 526/344; 524/434; 428/36.6

(57) ABSTRACT

A polyvinyl chloride (PVC) composition is proposed which comprises a PVC resin having a molecular weight distribution having a number average of M_{N}=60 kDa to M_{N}=70 kDa and a weight average of M_{W}=114 kDa to M_{W}=124 kDa, wherein the total composition has a chlorine content from 56% to 62%.

### CROSS-REFERENCE TO RELATED APPLICATIONS

This application is a National Stage of International Application No. PCT/EP2013/050081, filed on Jan. 4, 2013, and published in German as WO/2013/104562 A1 on Jul. 18, 2013. This application claims the benefit and priority of European Application No. 12000194.6, filed on Jan. 13, 2012. The entire disclosures of the above applications are incorporated herein by reference.

### BACKGROUND

This section provides background information related to the present disclosure which is not necessarily prior art.

### TECHNICAL FIELD

The invention relates to a polyvinyl chloride (PVC) composition, to a pipe, a channel, or a container for the passage and/or storage of chemically aggressive substances.

### DISCUSSION

Polyvinyl chloride (PVC) compositions, pipes, channels or containers for the passage and/or storage of chemically aggressive substances are known, as also are uses of polyvinyl chloride compositions. By way of example, it is known that rigid PVC, also known as unplasticized PVC, PVC-U, can be used in particular in plant construction for the construction of pipes and of containers. A problem with this material is that it has an upper temperature limit of about 60° C. to 70° C., resulting from the Vicat softening point of the material. In many cases, plant construction requires materials that withstand a higher temperature. One possibility then is to use what is known as postchlorinated PVC, PVC-C, which has a markedly higher Vicat softening point.

However, this material also has serious disadvantages: firstly it is markedly more expensive than PVC-U, and it is moreover more difficult to weld and/or to thermoform. Processing of PVC-C and installation of components comprising this material is therefore complicated and expensive. In particular welds often require complicated and expensive heat-conditioning. Another factor is that the chemicals resistance profile of PVC-C is restricted for many applications in particular in the chlorine industry because impact modifiers have to be added. In particular, the material has an inherent lack of stability when in contact with highly basic media. Use of PVC-C also often appears to be questionable for reasons of cost.

A known alternative, in particular for passage and/or storage of basic media, especially at relatively high temperatures, is to resort to the material polypropylene, PP. However, this material also has serious disadvantages, because it exhibits about twice the thermal expansion of PVC polymers, and exhibits relatively high susceptibility to stress cracking when exposed to aqueous alkalis. Here again it is often advisable, because of stresses arising in the material, that welds are heat-conditioned after production, and that very close attention is paid to the correct selection of the most suitable PP compounds, and also to correct welding techniques and to stress minimization during installation. Relaxation of stresses proceeds extremely slowly here and requires more than 24 hours even at a temperature above 100° C.

Provision of what are known as composite pipes is also known, these having a thermoplastic inner wall, what is known as an inliner, comprising by way of example PVC-U, PVC-C, or PP. This inner wall has been laminated to, and/or reinforced by, an exterior outer wall which comprises at least one glassfiber-reinforced thermoset resin, GRP. The thermoplastic inliner here acts as chemicals-resistant layer, in particular as corrosion barrier, while all mechanical loads are absorbed by the GRP outer wall. If the thermoplastic inliner comprises polyolefins such as polypropylene or polyethylene, PE, the inliner is linked to the GRP outer wall by a fusion process to incorporate a glass nonwoven, in particular a braided glassfiber material. In contrast, if the thermoplastic inliner comprises PVC-U or PVC-C, it is bonded to the GRP outer wall via at least one adhesive resin.

Linkage of an inliner comprising polypropylene to the GRP outer wall with the aid of a glass nonwoven raises particular practical difficulties and places high demands on the processor's manual skills and quality assurance system. Exposure to severe and frequent temperature changes of the type that regularly arise in particular in the chlorine industry due to frequent shutdown and start-up of sections of plant induces high shear forces in the region of the linkage between the GRP outer wall and the PP inliner, because of large differences in the thermal expansion between the PP inliner and the GRP outer wall. The difference, typically by a factor of four, between the coefficients of thermal expansion of the inliner and of the outer wall also restricts the wall thickness of the chemicals-resistant inliner to a range below 8 mm. There is therefore always the risk of cracking in the inliner and delamination of same from the GRP outer wall. When the medium used is aqueous alkali, the aqueous alkali that penetrates into these cracks of the inliner then reacts directly and extremely rapidly with the glass nonwoven that has been incorporated by the fusion process; this is especially the case at the high process temperatures that prevail in this area in the chlorine industry, and it can lead to destruction of large areas of the glass nonwoven. In particular, the glassfiber braid exerts a capillary effect by virtue of which chemically aggressive aqueous alkali is, in a manner of speaking, absorbed into the braid. This accelerates the destruction of the inliner-outer-wall bond and leads to rapid propagation of the destruction along the length of the pipe. The capillary effect of the glass nonwoven can cause damage to propagate at a velocity of several meters of pipeline within just a few days. The overall effect when pipes of this type are used is a risk of regular, very rapid failure of the entire pipe system, generating very high failure costs due to unplanned plant shutdown and a resultant requirement for complete replacement of the pipe system.

Other known possibilities are use of polyvinylidene-fluoride-(PVDF)-GRP composite pipes or use of ethylene-chlorotrifluoroethylene as material. These solutions are very expensive and are frequently rejected for reasons of cost. PVDF also lacks resistance to the media encountered under the relevant conditions.

Overall, it is apparent that many different materials are used specifically in the chlorine industry sector. This is a serious disadvantage, for reasons of cost and also in respect of logistic issues.

### SUMMARY OF THE INVENTION

It is therefore an object of the invention to provide a PVC composition which does not have the disadvantages mentioned. In particular, the composition is intended to be versatile in use in a comparatively high temperature range with superior resistance to chemicals, in particular to aqueous alkalis. Another object of the invention is to provide a pipe, a channel, or a container for the passage and/or storage of chemically aggressive substances which does not have the disadvantages mentioned. The products mentioned are intended to be amenable to low-cost production, to have high thermal stability, and also to have high resistance to aggressive chemical substances, for example aqueous alkalis. Another object of the invention is to provide uses for a PVC composition, where the disadvantages mentioned do not occur. A final object of the invention is to provide uses of a pipe, of a channel, or of a container for the passage and/or storage of a chemically aggressive substance, where the disadvantages mentioned do not occur.

The object is preferably achieved with a PVC resin with monomodal molecular weight distribution with a number average of M_{N}=from 60 kDa to M_{N}=70 kDa and a weight average of M_{W}=from 114 kDa to M_{W}=124 kDa. The chlorine content of the entire composition is moreover from 56% to 62%. The expression “entire composition” implies that the PVC composition can comprise other constituents alongside the PVC resin. The chlorine content stated in percent by weight is based on the entire composition and not exclusively on the PVC content thereof. The expression “PVC resin” refers to the polyvinyl chloride component or the PVC content of the entire composition, and the PVC resin here can itself comprise more than one resin component, or can have been formed from more than one resin component. The expression “PVC resin component” here in particular also comprises polyvinyl chloride with different chlorine content. The clever combination of a molecular weight distribution characterized by the parameter ranges mentioned with a chlorine content defined by the range mentioned leads to surprising properties of the polyvinyl chloride composition. This has high resistance to chemicals, in particular to aqueous alkalis, at high temperatures (≦95° C.), and is at the same time inexpensive and easy to process. In particular, it is possible with the same composition to extrude pipes with external diameter up to 600 mm and wall thicknesses in particular of an inliner ≦15 mm, sheets with wall thicknesses ≦10 mm, and welding rod with diameter from 2 mm to 4 mm. The composition, and components comprised by same, is/are weldable, thermoformable, and/or adhesively bondable. In particular, in the event of reinforcement of a GRP layer it is possible to use commercially available adhesive resin to provide linkage. The polyvinyl chloride composition here has a processing temperature in practically the same range as that of known PVC-U. At the same time, the polyvinyl chloride composition, and components thereof, readily comply with the requirements in accordance with DIN 8061/62 for pressurized pipes. The overall result is therefore that the polyvinyl chloride composition can be inexpensive in use, is extremely resistant to chemicals, is easy to process, and is very stable. It is moreover compatible with components which comprise known PVC-U.

It is preferable that the PVC resin has a monomodal molecular weight distribution with a number average of M_{N}=from 63 kDa to M_{N}=67 kDa and a weight average of M_{W}=from 116 kDa to M_{W}=120 kDa. It is preferable that the chlorine content of the entire composition is from 57% to 60%.

The molecular weight distribution is preferably determined by gel permeation chromatography (GPC) after removal of the constituents insoluble in tetrahydrofuran (THF). THF is used as solvent, preferably with a flow rate of 0.8 mL/min. Polystyrene calibration standards are used here, and it is preferable to use an RI detector from Agilent. The separating column used preferably comprises two 10μ 8×600 mm PSS SDV columns.

It is preferable that the calibration standards are purchased from PSS Polymer Standards Service GmbH, and the standards used here are preferably the following:

| Batch No. | M_{P}/Da | M_{N}/Da | M_{W}/Da |
|---|---|---|---|
| Ps 200504 | 1820 | 1770 | 1920 |
| Ps 6126 | 3470 | 3260 | 3460 |
| Ps 24076 | 10400 | 10000 | 10300 |
| Ps 12030 | 19600 | 18600 | 19100 |
| Ps 7122 | 34300 | 33000 | 34000 |
| Ps 1073 | 67500 | 64000 | 65000 |
| Ps 10068 | 100000 | 92000 | 96000 |
| Ps 5070 | 250000 | 236000 | 248000 |
| Ps 7082 | 336000 | 330000 | 335000 |
| Ps 61120 | 556000 | 536000 | 546000 |
| Ps 2056 | 824000 | 769000 | 803000 |
| Ps 21036 | 1044000 | 970800 | 1103000 |
| Ps 2040 | 2470000 | 1810000 | 2010000 |

It is preferable that the chlorine content of the entire composition is determined by way of a Schöniger flask test followed by titrimetric determination of chlorine content.

The PVC composition is preferably free from polypropylene, polyvinylidene fluoride, and/or ethylene-chlorotrifluoroethylene.

Preference is given to a PVC composition which features a Vicat softening point >88° C., preferably >90° C. The PVC composition is therefore versatile in use in particular in the chemical industry, very particularly in the chlorine industry, where very many processes proceed at a temperature of about 60° C. to about 92° C. In many cases it is then no longer necessary to resort to design materials that are more expensive and, in the final analysis, less stable.

Preference is also given to a PVC composition which features absence of impact modifiers. The composition is particularly preferably free from added impact modifiers. It is therefore preferable that no impact modifiers are added to the formulation for the PVC composition. This results in markedly higher stability in particular with respect to contact with highly basic media, because the lack of stability of known compositions in this respect is in particular caused by added impact modifiers.

Preference is also given to a PVC composition which features absence of chalk and/or calcium and/or magnesium. The composition is particularly preferably free from added chalk and/or added calcium and/or added magnesium. It is therefore preferable that no chalk and/or no calcium and/or no magnesium and, respectively, no substances comprising chalk and/or no substances comprising calcium and/or no substances comprising magnesium are added to the formulation for the composite. Chalk is substantially responsible for lack of resistance of known materials to acid, and the polyvinyl chloride composition therefore has markedly increased resistance to acids. The chlorine industry generally requires minimized content of calcium and/or magnesium in components that it uses. The PVC composition is therefore particularly suitable for use in the chlorine industry.

Preference is also given to a PVC composition which features the presence of tin. As an alternative, or in addition, it is preferable that the PVC composition comprises a component which comprises tin. This can by way of example be an organometallic stabilizer component. It is preferable that stabilization by lead-containing components is thus avoided, the PVC composition thus being toxicologically nonhazardous. At the same time, stabilization based on tin or on tin-containing components is very efficient.

These products feature the presence of a PVC composition in accordance with any of the embodiments described above. They can therefore be produced easily and at low cost, and have high chemicals resistance, and also a high Vicat softening point. They are therefore in particular resistant to chemicals and to temperature changes. The pipe or the channel is preferably in particular used in plant construction, in particular in large-scale chemical plant construction, very particularly in the chlorine industry. It is possible here to omit any complicated and expensive post-conditioning of welds, because the PVC composition can be processed easily and at a temperature similar to that for known PVC-U. Complete failure of a pipe system is unlikely because the polyvinyl chloride composition is very resistant to chemical stresses and to high temperature, and also—by virtue of its coefficient of thermal expansion, which is markedly lower than that of the known compositions—in particular to temperature variations. It is moreover also possible in principle to realize an unsupported pipe structure based on the PVC composition. In particular, in many cases it is not essential to design the pipe as composite pipe.

Reference is also given to a pipe which features the design of a composite pipe. The composite pipe comprises an outer wall which comprises glassfiber-reinforced thermoset resin. It also has an inner wall which comprises a PVC composition in accordance with any of the embodiments described above. The advantages already mentioned are obtained here. Furthermore, the difference between the coefficient of thermal expansion of the PVC composition and the coefficient of thermal expansion of the glassfiber-reinforced thermoset resin is smaller than is the case in known composite pipes which by way of example comprise polypropylene. Occurrence of high shear forces is thus minimized in the event of frequent and in particular sudden temperature changes, and the composite pipe is therefore subject to less mechanical load.

Particular preference is given to a composite pipe which features bonding of the inner wall to the outer wall via at least one adhesive resin. This type of linkage is possible by virtue of the properties of the polyvinyl chloride composition. There is therefore no need to use any glass nonwoven, and the problems associated therewith are thus avoided. The use of an adhesive resin can give a chemical bond instead of a mechanical bond, with resultant very high reproducibility of a higher quality standard in respect of shear-resistance of the bond in the composite of GRP height and PVC inliner. In the transition region between outer wall and inner wall there is none of the accelerated advance of corrosion that could in particular propagate rapidly along the length of the pipe. Damage to the pipe, if it occurs at all, is therefore locally restricted, and there is therefore no failure of the entire pipe system. It is possible to replace damaged pipes within narrowly restricted local regions. By virtue of the very good processability of the PVC composition and of the composite pipes comprising this, it is actually possible to cut damaged pipe sections out from a pipe and to replace these with new, appropriate pipe sections. These can easily be secured, at the resultant interfaces, preferably being welded thereto, without any requirement for expensive and complicated heat-conditioning steps.

The PVC composition in accordance with any of the embodiments described above is used in the invention as material resistant to chemicals and to temperature changes for the production of pipes, channels, containers, sheets, moldings, and/or welding rod. The resultant products are inexpensive and easy to process, and are extremely resistant to chemicals.

The PVC composition in accordance with any of the embodiments described above is used as material resistant to chemicals and to temperature changes for a pipe, a channel, or a container. It is particularly preferably used for the production of what is known as liner-composite component. This is by way of example a composite pipe which has a GRP outer wall and a thermoplastic inliner which comprises the PVC composition in accordance with any of the embodiments described above, preferably as inner wall that is resistant to chemicals. The advantages already described are obtained here.

Finally, the object is also achieved by providing the use of a pipe, of a channel, or of a container. The product in accordance with one of the embodiments described above is used for the passage and/or storage of chemically aggressive substance which comprises at least one component selected from the group consisting of preferably aqueous potassium hydroxide or sodium hydroxide solution preferably with ≦50% of KOH or NaOH, preferably aqueous potassium chloride solution—preferably with ≦350 g/L of KCl, preferably aqueous sodium chloride solution—preferably with ≦350 g/L of NaCl, preferably aqueous hypochlorite solution—preferably with ≦18% of active chlorine solution, and a concentrated mineral acid. The mineral acid preferably comprises concentrated sulfuric acid—preferably with ≦120% of SO₃, concentrated hydrochloric acid ≦37%, concentrated nitric acid ≦68%, or concentrated hydrofluoric acid. The PVC composition which comprises the product is very resistant to chemicals in relation to acids and aqueous alkalis, and this can therefore readily be used for the passage and/or storage of aggressive pure substances or substance mixtures, in particular of the substances mentioned. The advantages already described are obtained here.

### BRIEF DESCRIPTION OF THE DRAWINGS

The invention is described in more detail below, and in particular preferred usage examples of the PVC composition are described in more detail.

The drawings described herein are for illustrative purposes only of selected embodiments and not all possible implementations, and are not intended to limit the scope of the present disclosure.

In this context, the figures show the following:

FIG. 1 is a diagrammatic representation of the tensile strength (DIN EN ISO 527) in MPa plotted against the temperature in ° C. for three different PVC compositions. Curve R 33 here relates to the PVC formulation (troisdorfrot) from Georg Fischer DEKA GmbH. Curve 33-7-10 relates to a prototype formulation from Georg Fischer DEKA GmbH, slightly modified in comparison with PVC-U (troisdorfrot). The curve identified by 33-19-10 relates to the preferred inventive example mentioned below of the PVC composition of the invention.

FIG. 2 is a diagrammatic representation of the tensile modulus of elasticity (DIN EN ISO 527) in MPa plotted against the temperature in ° C. for four different plastics compositions. The curve identified as PP 2222 here relates to a standard polypropylene composition regularly used in the chlorine industry. For the other curves, reference is made to the information relating to FIG. 1.

FIG. 3 is a double-logarithmic diagrammatic representation of performance in the long-term failure test under internal hydrostatic pressure, specifically plotting the tangential stress in MPa against time in hours, where the continuous straight black line represents the standard performance in accordance with DIN 8061/62 for PVC-U at 80° C., while the individual square points represent measurements on the PVC composition in accordance with the preferred inventive example described here, at a temperature of 90° C. The measurement point situated markedly below an imaginary straight line running through the three square measurement points indicates a value at which the test was terminated.

### DETAILED DESCRIPTION OF THE PREFERRED EMBODIMENTS

Example embodiments will now be described more fully with reference to the accompanying drawings.

It is preferable to produce the PVC composition by gelling, or homogenizing, various raw-material PVC-resin components with one another. The various raw-material resin components here can have various molecular weights and chlorine contents. It is particularly preferable that the various raw-material resin components are selected in such a way that they can be homogenized or gelled without decomposition of lower-melting-bond components, the final result here being a monomodal molecular weight distribution for the PVC resin of the PVC composition.

To this end, it is preferable to add a gelling agent which particularly preferably comprises an acrylate-based gelling agent.

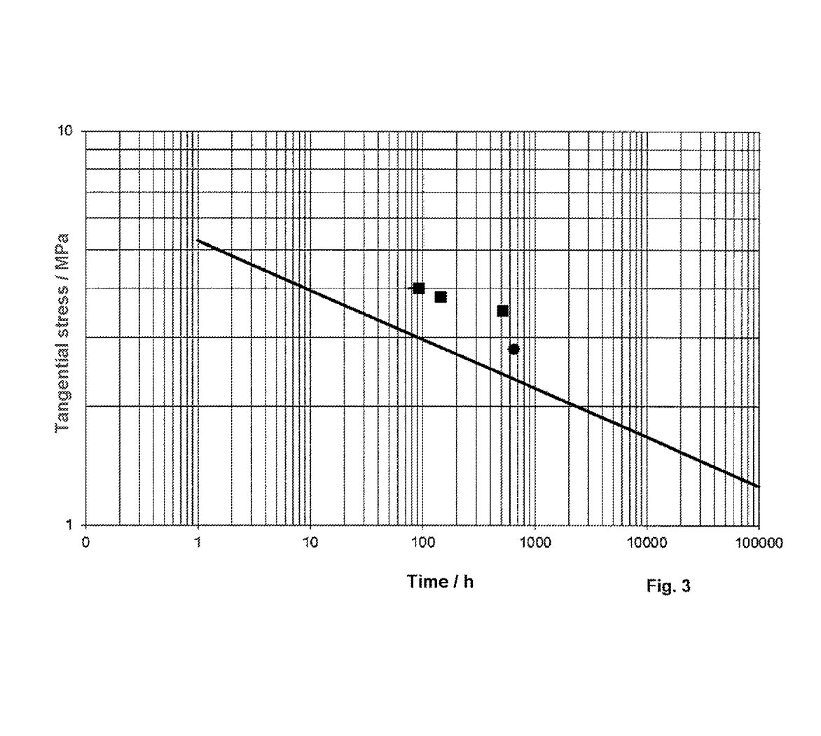

The final resultant PVC composition markedly exceeds the performance required in accordance with DIN 8061/62 in the long-term failure test under internal hydrostatic pressure for a temperature of 80° C., and indeed at a temperature of 90° C. (FIG. 3).

During the production of the PVC composition, it is preferable to omit any addition in particular of processing aids and/or lubricants that are susceptible to hydrolysis and/or to oxidation. The resistance of the PVC composition to chemicals is thus further increased. If lubricants and/or processing aids are added, it is preferable to ensure that these have minimal susceptibility to hydrolysis and/or oxidation.

It is preferable that the PVC composition is free from calcium stearate, in particular free from added calcium stearate. It is very particularly preferable that it is completely free from any stearate, in particular from added stearate. In this case the resistance of the PVC composition to chemicals is in particular markedly increased in comparison with known compositions because it comprises no calcium, and also comprises no carboxylate groups.

It is preferable that the PVC composition comprises a first PVC resin component which comprises, and preferably consists of unplasticized PVC. It is particularly preferable that the first PVC resin component is characterized by the CAS number 9002-86-2.

It is preferable that the PVC composition moreover comprises a second resin component which comprises a polymer with higher chlorine content than the first resin component. It is particularly preferable that the second resin component has a molecular weight distribution with a lower number average and a lower weight average than the first resin component. It is preferable that the second resin component is a PVC resin component. It is very particularly preferable that the second resin component is characterized by the CAS number 68648-82-8.

It is possible that the PVC composition comprises more than two resin components.

The first PVC resin component preferably has a molecular weight distribution with a weight average M_{W} of from 140 kDa to 154 kDa, with preference from 141 kDa to 153 kDa, with preference from 142 kDa to 152 kDa, with preference from 143 kDa to 151 kDa, with preference from 144 kDa to 150 kDa, with preference from 145 kDa to 149 kDa. The number average M_{N} of the molecular weight distribution of the first PVC resin component is preferably from 70 kDa to 77 kDa, with preference from 71 kDa to 76 kDa. The chlorine content of the first PVC resin component is preferably from 54% to 60%, with preference from 55% to 59%, with preference from 56% to 58%.

It is preferable that the second resin component has a molecular weight distribution with a weight average M_{W} of from 101 kDa to 113 kDa, with preference from 102 kDa to 112 kDa, with preference from 103 kDa to 111 kDa, with preference from 104 kDa to 110 kDa, with preference from 105 kDa to 109 kDa. The number average M_{N} of the molecular weight distribution of the second PVC resin component is preferably from 54 kDa to 63 kDa, with preference from 55 kDa to 62 kDa, with preference from 56 kDa to 61 kDa, with preference from 57 kDa to 60 kDa. The chlorine content of the second resin component is preferably from 62% to 69%, with preference from 63% to 68%, with preference from 64% to 67%, with preference from 65% to 66%.

The ratio of the first resin component to the second resin component in the PVC composition is preferably from 40:60 to 60:40, preferably from 45:55 to 55:45, preferably from 48:52 to 52:48.

The PVC composition preferably moreover comprises a tin stabilizer, preferably monooctyltin or dioctyltin, or a mixture of mono- and dioctyltin. It is preferable that the tin stabilizer comprises a compound with the CAS number 15571-58-1 or a compound with the CAS number 27107-89-7, or a mixture of said compounds. The proportion by mass of the tin stabilizer in the PVC composition is preferably from 0.1 phr to 1 phr, preferably from 0.3 phr to 0.8 phr, preferably from 0.4 phr to 0.7 phr.

The unit phr (parts per hundred rubber) used here is parts per 100 parts of all resins of the composition.

It is preferable that the PVC composition comprises titanium dioxide, with particular preference having the CAS number 13463-67-7, its proportion by mass being from 0.05 phr to 0.4 phr, preferably from 0.09 phr to 0.3 phr, preferably from 0.1 phr to 0.25 phr.

The PVC composition preferably moreover comprises at least one pigment and/or at least one dye, with particular preference selected from the list consisting of compounds with the CAS numbers 6536-46-2, 57455-37-5 and 15782-05-5. In particular, it is possible to mix a plurality of pigments and/or dyes as required by the desired color of the PVC composition. The proportion of pigments or, respectively, dyes in the PVC composition is preferably from 0.1 phr to 1.0 phr, with preference from 0.4 phr to 0.8 phr, with preference from 0.6 phr to 0.7 phr.

It is moreover preferable that the PVC composition comprises a first, oxidized polyethylene wax component, preferably based on the CAS number 9002-88-4, preferably with a drop point (Mettler Drop Point; ASTM D3954) of 101° C. and with an acid number (ASTM D1386) of 15 mg KOH/g. The proportion by mass of the first, oxidized polyethylene wax component present is preferably from 0.5 phr to 1.1 phr, preferably from 0.6 phr to 1 phr, preferably from 0.65 phr to 0.1 phr.

It is preferable that the PVC composition comprises a second, oxidized polyethylene wax component, with preference likewise based on the CAS number 9002-88-4, with preference having a drop point (Mettler Drop Point; ASTM D3954) of 140° C. and with an acid number (ASTM D1386) of 7 mg KOH/g. It is preferable that the second polyethylene wax component differs from the first polyethylene wax component in the drop point and the acid number. It is preferable that the proportion by mass of the second polyethylene wax component is from 0 phr to 0.4 phr, preferably from 0.05 phr to 0.2 phr.

It is preferable that the PVC composition comprises a Fischer-Tropsch wax component, with preference an unfunctionalized hard Fischer-Tropsch paraffin with a drop point (DGF M-III 3) of from 108 to 114° C. and with an acid number (DGF M-IV 2) of <1 mg KOH/g. It is preferable that the proportion by mass of Fischer-Tropsch wax component is from 0.3 phr to 0.7 phr, preferably from 0.4 phr to 0.6 phr.

A significant factor in the composition of the oxidized polyethylene wax components and the Fischer-Tropsch wax component is that, as far as possible, no additional functional groups that could have a disadvantageous effect on the chemical stability of the PVC composition are introduced into same. An equally significant factor is omission of conventional additives which comprise calcium, for example calcium stearate. The overall intention is to avoid integration of chemically unstable functionalities into the composition.

Finally, the precise proportions and natures of the oxidized polyethylene wax components and Fischer-Tropsch wax components are preferably selected to be appropriate for the specific machinery available for the production of the PVC composition, and for the processing conditions.

The PVC composition preferably moreover comprises at least one acrylate-based gelling and/or processing aid, particularly preferably with the CAS number 27136-15-8. The proportion by mass of the gelling and/or processing aid is preferably from 0.8 phr to 1.2 phr, with preference from 0.9 phr to 1.1 phr, with preference from 0.95 phr to 1.05 phr, with preference from 0.97 phr to 1.03 phr.

The PVC composition preferably moreover comprises at least one antioxidant, particularly preferably with the CAS number 6683-19-8. The proportion by mass of the antioxidant is preferably from 0.5 phr to 1.4 phr, with preference from 0.8 phr to 1.2 phr, with preference from 0.9 to 1.1 phr.

It is preferable that the PVC composition is free from flow aids other than of the first and/or of the second polyethylene wax component, in particular from added flow aids.

One preferred inventive example of the PVC composition comprises 48 parts of a first PVC resin component with the CAS number 9002-86-2. This example comprises 52 parts of a second PVC resin component with the CAS number 68648-82-8. In this case, the total proportion of the PVC resin components is 100. All of the parts mentioned here are therefore based, in the final analysis, on 100 parts of all resins, i.e. are stated in phr. The inventive example further comprises 0.5 part of a tin stabilizer which comprises constituents with the CAS numbers 15571-58-1 and 27107-89-7. It moreover comprises 0.1 part of titanium dioxide with the CAS number 13463-67-7. There is 0.65 part present of a pigment component and/or dye component, comprising at least one compound with a CAS number selected from the list consisting of 6536-46-2, 57455-37-5 and 15782-05-5. There is 0.9 part present of a first oxidized polyethylene wax component with a drop point (Mettler Drop Point; ASTM D3954) of 101° C. and an acid number (ASTM D1386) of 15 mg KOH/g, and 0.1 part present of a second oxidized polyethylene wax component with a drop point (Mettler Drop Point; ASTM D3954) of 140° C. and an acid number (ASTM D1386) of 7 mg KOH/g. The total proportion of the oxidized polyethylene wax components therefore amounts to 1.0 part. There is 0.4 part present of a Fischer-Tropsch wax component with a drop point (DGF M-III 3) of from 108 to 114° C. and an acid number (DGF M-IV 2) of <1 mg KOH/g. There is moreover one part of an acrylate-based gelling and/or processing aid present with the CAS number 27136-15-8. There is one part of an antioxidant present with the CAS number 6683-19-8. The sum of all of the parts in this inventive example is therefore 104.65.

A method conventional in the art is used to mix the various components of the PVC composition, which are gelled and processed, and then preferably extruded.

Experimental data are used below to provide more detailed confirmation of properties of the PVC composition of the invention in accordance with the preferred inventive example. DEKADUR Plus here is a PVC composition in accordance with the preferred inventive example.

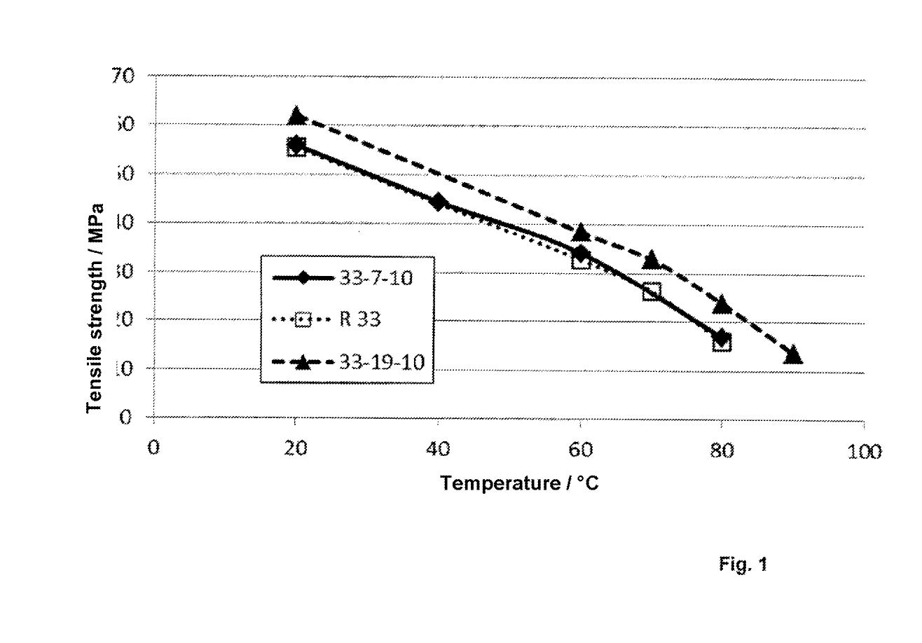

FIG. 1 shows the tensile strength in accordance with DIN EN ISO 527 of various PVC compositions plotted against temperature. It can be seen here that the curve identified as 33-19-10, relating to DEKADUR Plus, is always above the other two curves. In particular, the tensile strength of DEKADUR Plus is markedly increased in comparison with the other two materials in the temperature range above 60° C. The curve identified as R 33 here relates to the formulation PVC-C (troisdorfrot) from Georg Fischer DEKA GmbH, and the curve identified as 33-7-10 relates to a slightly modified prototype formulation based on PVC-U (troisdorfrot) from Georg Fischer DEKA GmbH. Both comparative formulations comprise a proportion of <3% of chalk.

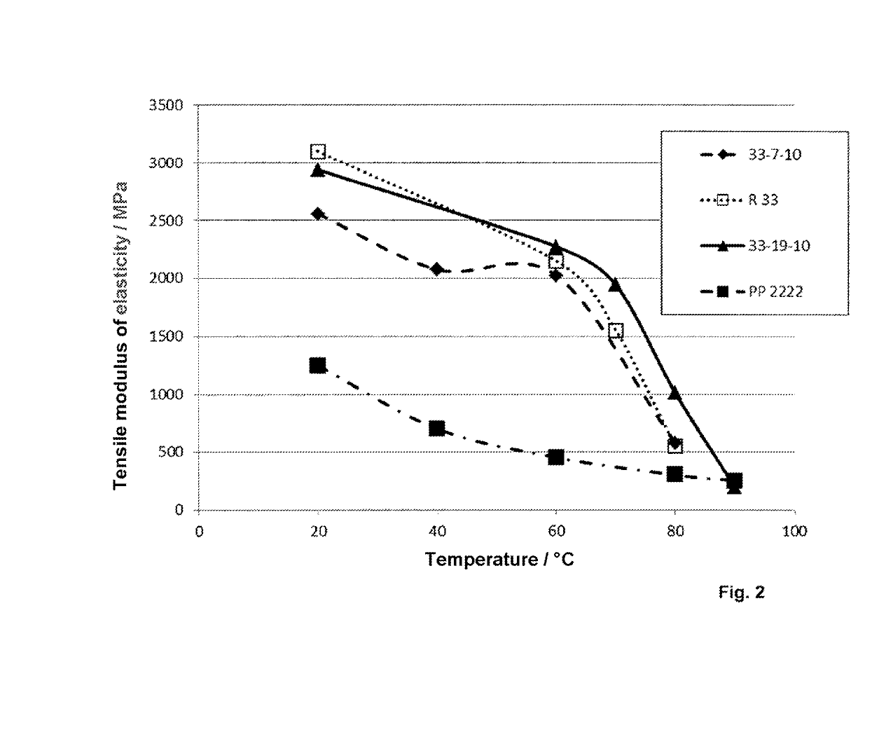

FIG. 2 shows the tensile modulus of elasticity in accordance with DIN EN ISO 527 of various compositions plotted against temperature. Here again, it can be seen that, in particular in the temperature range >60° C., DEKADUR Plus has a higher modulus of elasticity than the comparative formulations. The curve identified as PP 2222 here relates to a standard polypropylene formulation frequently used in the chlorine industry in particular for the catholyte circuit. Reference is made to the information relating to FIG. 1 in respect of the nomenclature for the other curves and of the compositions to which these relate.

FIG. 3 shows the performance in the long-term failure test under internal hydrostatic pressure, specifically the tangential stress of DEKADUR Plus plotted against time (square measurement points) in comparison with the 80° C. DIN curve for PVC-U, represented as continuous straight line, in accordance with DIN 8061/62. The values for DEKADUR Plus were measured here at a temperature of 90° C. The measurement point represented as a circle indicates a measurement that was terminated because the prescribed tangential stress would require a measurement time of some decades. Nevertheless, it can be seen that this measurement point, too, is clearly above the standard curve. The performance determined experimentally for DEKADUR Plus at a temperature of 90° C. is also confirmed via extrapolation by using pressure-increased tests in accordance with Miner's rule. From FIG. 3 it can clearly be seen that pipes which comprise DEKADUR Plus are more resistant to pressure at a temperature of 90° C. than is required by the standard DIN 8061/62 for a temperature of 80° C.

The performance of DEKADUR Plus in terms of resistance to chemicals is confirmed on the basis of the experimental data presented in the tables below. Resistance to chemicals was determined by undertaking immersion tests involving contact between media and all sides of the samples used. Sample material used comprised extruded pipes with external diameter 63 mm and wall thickness 4.7 mm.

PVC-U 1 here indicates the formulation PVC-U (troisdorfrot) from Georg Fischer DEKA GmbH, which comprises a lead stabilizer. PVC-U 2 indicates a prototype formulation from Georg Fischer DEKA GmbH based on PVC-U (troisdorfrot), where a tin stabilizer is present instead of the lead stabilizer.

Both formulations PVC-U 1 and PVC-U 2 comprise a proportion of less than 3% of chalk. Other standard PVC-U formulations comprise a proportion of about 6% of chalk. To that extent, the formulations PVC-U 1 and PVC-U 2 are already better than other standard formulations in terms of their resistance to chemicals.

In the context of the tables below, PVC-C indicates the formulation DEKADUR C from Georg Fischer DEKA GmbH based on the raw material Temprite 88708.

TABLE 1

| | | Penetration | | |
|---|---|---|---|---|
| | | depth/μm | | Blister- |
| | Weight | (internal/ | Change in | ing/deforma- |
| Formulation | change/% | external) | Vicat/K | tion |
| PVC-U 1 | 11.1 | 610/520 | 4.4 | yes |
| DEKADUR | 7.8 | 550/480 | 0.9 | no |
| Plus | | | | |

The comparative values for PVC-U 1 and DEKADUR Plus collated in table 1 were obtained in a field test lasting three months during which the samples were exposed to moist chlorine gas using from 98.5% to 99.7% of chlorine, water vapor saturation, and oxygen as residual gas, at a temperature of from 85° C. to 90° C. The expression “field test” implies that the samples were exposed to moist chlorine gas during the actual operation of an industrial plant. The values in table 1 clearly show that under the experimental conditions stated DEKADUR Plus exhibits, in comparison with PVC-U 1, less change in weight, markedly less change of Vicat softening point, a smaller penetration depth both internally and externally, and also no blistering. DEKADUR Plus is therefore clearly more resistant to chlorination and to diffusion phenomena under the stated experimental conditions.

TABLE 2

| | | Penetration depth/μm |
|---|---|---|
| Formulation | Weight change/% | (internal/external) |
| PVC-U 1 | −1.00 | 490/510 |
| PVC-U with 7 phr | −0.80 | 630/770 |
| of acrylate-based | | |
| impact modifier | | |
| PVC-U with | 0.80 | 450/510 |
| stabilizer and | | |
| antioxidant | | |
| package of | | |
| DEKADUR Plus | | |

Table 2 shows an experiment in which the samples were exposed in a field test for seven months in a bypass of a bleaching plant in a paper mill to chlorine dioxide with 1% of ClO₂ with a proportion of 5% of solids (proportion of pulp—in essence proportion of wood) at a temperature of from 68° C. to 75° C. The formulation, stated as “PVC-U with 7 phr of acrylate-based impact modifier”, is based on a standard PVC-U formulation to which 7 phr of acrylate-based impact modifier was added. In contrast, the formulations PVC-U 1 and PVC-U 2 are free from impact modifiers. The formulation characterized as “PVC-U with stabilizer and antioxidant package of DEKADUR Plus” is a standard PVC-U formulation to which stabilizer components and antioxidant components were added as for DEKADUR Plus. The experiments to which table 2 refers were carried out in order to describe the effect of an impact modifier on the resistance of a PVC-U formulation to chemicals, and also in order to demonstrate the clear superiority of the stabilizers and antioxidants selected for the DEKADUR Plus formulation. The values stated in table 2 here clearly show the adverse effect of the impact modifier, in particular on penetration depth. In contrast, the formulation with the stabilizers and antioxidants of DEKADUR Plus has markedly better properties.

TABLE 3

| | | Penetration depth/μm |
|---|---|---|
| Formulation | Weight change/% | (internal) |
| PVC-U 1 | 0.45 | 258 |
| PVC-U 2 | 0.78 | 460 |
| DEKADUR Plus | 0.30 | 183 |

Table 3 relates to the resistance of various samples to nitric acid. The samples were exposed for a period of eight weeks to nitric acid with 55% of HNO₃ at a temperature of 60° C. The values stated in table 3 clearly show the marked advantages in the resistance of DEKADUR Plus to chemicals in comparison with PVC-U 1 and PVC-U 2 in relation to oxidizing mineral acids such as concentrated nitric acid.

TABLE 4

| | | Penetration depth |
|---|---|---|
| | | of black coloration due |
| Formulation | Weight change/% | to SO₃ |
| PVC-U 1 | 0.19 | Entire volume of sample |
| | | affected |
| DEKADUR Plus | 0.57 | Surface only |

Table 4 relates to the resistance of DEKADUR Plus to chemicals in comparison with PVC-U 1 in relation to concentrated sulfuric acid, where the samples were exposed for a period of three weeks to concentrated sulfuric acid (96%) at a temperature of 90° C. The completely different and improved corrosion performance of DEKADUR Plus is clearly seen here from the values in table 4. In particular, SO₃ diffusion is markedly retarded in the case of DEKADUR Plus.

TABLE 5

| | | Penetration depth |
|---|---|---|
| | | of black coloration due |
| Formulation | Weight change/% | to SO₃ |
| PVC-U 1 | 1.38 | Major diffusion into the |
| | | material with black |
| | | coloration |
| DEKADUR Plus | 1.22 | Surface only |
| DEKADUR Plus | 0.98 | Surface only |
| heat- | | |
| conditioned at | | |
| 4 h/95° C. | | |

Table 5 relates to the resistance of two DEKADUR Plus samples to chemicals in comparison with PVC-U 1 in relation to sulfur trioxide. The second DEKADUR Plus sample differs from the first in that it was heat-conditioned for four hours at 95° C. The samples were exposed for two weeks to a saturated SO₃ atmosphere in the gas phase over 20% oleum at 20° C. The values in table 5 here show that in the case of both samples the corrosion performance of DEKADUR Plus is markedly different and better than PVC-U 1. In particular, SO₃ diffusion is markedly retarded in the case of DEKADUR Plus. Heat-conditioning of the DEKADUR Plus sample further increases its robustness.

TABLE 6

| | DEKADUR Plus | | PVC-U 2 | PVC-U 1 | PVC-C | Standard |
|---|---|---|---|---|---|---|
| Storage time/ | 3 | 12 | 8 | 8 | 3 | |
| weeks | | | | | | |
| Delta mass/% | 0.097 | 0.127 | 0.141 | −0.027 | 0.208 | Gravimetric |
| Delta color | none | slightly | slightly | very marked | beige | Visual |
| | | darkened | darkened | brown coloration | coloration | |
| Penetration | not determinable | | | | | Microscopic |
| depth | | | | | | (visual, XRF, |
| | | | | | | indicator) |
| Delta Vicat/K | 5.4 | 6 | 3.1 | n.d. | 1.3 | ISO 306 |
| Delta modulus | 14.6 | 14.7 | 2 | 3.9 | −7.6 | DIN EN ISO |
| of elasticity/% | | | | | | 527 |
| Delta tensile | 8.1 | 11.3 | 15.9 | 21.4 | 8.9 | |
| strength/% | | | | | | |
| Delta tensile | −23.4 | −19.9 | −32.9 | −56.8 | −13.1 | |
| strain at break/% | | | | | | |

Table 6 relates to property changes of various samples of materials specified in the table in relation to concentrated aqueous sodium hydroxide solution (32%) at a temperature of 95° C., in comparison with the data for a zero sample, i.e. a freshly produced sample not exposed to the chemical. Various property changes are stated for the various samples in the aqueous alkali as a function of a storage time in weeks. These are the change in mass, a color change, the penetration depth, the change in Vicat softening point, the change in modulus of elasticity, the change in tensile strength, and the change in tensile strain at break. These values stated in table 6 show that in the case of DEKADUR Plus the hardening or property change known for PVC compositions, inter alia the sinter effect, has already taken place during the course of the first three weeks, with no significant subsequent change. Attack of the aqueous alkali here takes place only marginally at the surface. This confirms the corrosion resistance of DEKADUR Plus in comparison with PVC-U 1, PVC-U 2, and in particular PVC-C, even at high temperature. It can very particularly be seen that resistance to aqueous sodium hydroxide solution is much higher for DEKADUR Plus than for PVC-C, the poor resistance of which is in particular due to the added impact modifier.

TABLE 7

| | | | Penetration | Penetration |
|---|---|---|---|---|
| | Weight | Weight | depth/μm | depth/μm |
| Formulation | change/% | change/% | (internal) | (internal) |
| Storage | 3 | 8 | 3 | 8 |
| time/weeks | | | | |
| PVC-U 1 | 0.71 | n.d. | 494 | n.d. |
| PVC-U 2 | 1.08 | 1.37 | 603 | 906 |
| DEKADUR | 0.33 | 0.53 | 868 | 1215 |
| Plus | | | | |

Table 7 relates to a test in which the samples were respectively exposed for three or eight weeks to concentrated hydrochloric acid (35%) at 60° C. The weight change and penetration depth (internal) are stated for the respective storage time. Here again it can be seen that DEKADUR Plus has better properties than PVC-U 1 and PVC-U 2. In particular, DEKADUR Plus absorbs markedly less of the hydrochloric acid. This property has great advantages during the use of pipes which comprise DEKADUR Plus as liner. The lower absorption/sorption due to a smaller extent of reaction with hydrochloric acid is attended by accelerated diffusion, and the penetration depth is therefore increased in the case of DEKADUR Plus.

TABLE 8

| | | Penetration depth/μm |
|---|---|---|
| Formulation | Weight change/% | (internal) |
| DEKADUR Plus | 0.51 | 1126 |
| PVC-U 1 | 0.27 | 1239 |
| PVC-U 2 | 0.24 | 1150 |
| PVC-C | 3.21 | 588 |

Finally, table 8 relates to a test in which the samples were exposed for three weeks to concentrated hydrofluoric acid (40%) at 40° C. The values from table 8 here show that PVC-C absorbs hydrofluoric acid to a very high extent via reaction with formulation constituents. This results in retarded diffusion, i.e. lower penetration depth. The performance of DEKADUR Plus in relation to hydrofluoric acid and to other acids represents a very good compromise, where the permeation behavior of DEKADUR Plus is substantially the same as that of PVC-U and thus markedly different in particular from that of PVC-C.

Other findings relating to the PVC composition and to components present therein are the following:

Thermal stress relaxation takes place within as little as from 1 to 2 hours at a temperature of 95° C., for example during the welding or laying of components which comprise the PVC composition. This permits low-cost heat-conditioning of an entire pipe system after installation of same by passing hot water through the system. There is therefore no need for extremely expensive heat-conditioning steps using external heating tapes. It is also possible, in particular in the chlorine industry or in other application sectors where hot media come into contact with the PVC composition, to heat-condition the components during operation directly on start-up of a plant.

The PVC composition or components which comprise this, for example pipes, channels, and/or containers, are preferably useful in particular in the following sectors:

By virtue of their high resistance to chemicals and to temperature changes, they are suitable for contact with very-high-purity saline solutions, for example high-purity sodium chloride solution or high-purity potassium chloride solution, in particular in the temperature range of about 50° C. to about 80° C., and also if necessary with chlorine contamination of the solutions and varying pH values. In comparison with the PVC composition of the invention, use of PVC-C, which is possible in this sector, is very much more expensive because of the higher raw-materials price and markedly more difficult processing. Composite systems made of PP inliner and GRP outer wall often fail within a few months because of embrittlement and/or corrosion due to the high level of chlorine contamination.

Another suitable application sector for the PVC composition or components which comprise this is the catholyte circuit in an electrolytic chlorine plant. A material typically occurring here is potassium hydroxide solution or sodium hydroxide solution of strength about 30% to about 50% at a temperature of about 85° C. to about 92° C. Use of standard PVC-U is impossible for thermal reasons. Nor is PVC-C a suitable material, because it has poor resistance to aqueous alkalis. Composite materials of PP/GRP result in the disadvantages already mentioned. In contrast, the PVC composition and products which comprise this provide the advantage of low-cost production, good processability, and ideal resistance to chemicals and also to temperature changes.

It is also possible to use the PVC composition, or a product which comprises this, in an anolyte circuit in the chlorine electrolysis sector. Materials occurring here—depending on the conduct of the process, in particular on the pH value—are not only elemental chlorine but typically hypochlorous acid or, in downstream processes, a sodium hypochlorite solution.

Another particular possibility is use in sodium hypochlorite production, for example in chlorine removal systems of chlorine plants, and there are also other applications in connection with sodium hypochlorite, preferably at a temperature of 60° C. Sodium hypochlorite is generally stabilized by bases. It is frequently produced by introducing chlorine gas into a sodium hydroxide solution. It is therefore difficult to use materials comprising PVC-C, because, as already described, this has poor resistance to bases. The maximum temperatures arising in particular in chlorine-removal units are unacceptable for materials comprising standard PVC-U. Polyolefins are not stable under the conditions prevailing in this sector. Here again, the polyvinyl chloride composition or a product which comprises this accordingly provides a low-cost solution for an application sector which places stringent requirements on the materials used.

It is also possible to use the PVC composition or a product which comprises this for the production of oxygen supply lines, where a thermoplastic inliner is required to have low flammability: by way of example it is possible to replace, or to avoid, expensive pipes which comprise polyvinylidene fluoride (PVDF) as inliner material and a GRP outer wall.

Finally, it is also possible to use the polyvinyl chloride composition for the production of lines, pipes, channels, and/or containers for concentrated sulfuric acid of strength >90%, in particular even at relatively high temperature and very particularly at varying temperature. It is thus possible by way of example to replace, or avoid, materials which comprise expensive ethylene-chlorotrifluoroethylene and/or perfluorinated plastics.

Another possible use is for the production of lines, pipes, channels, and/or containers for concentrated nitric acid or compositions which comprise nitric acid and/or which comprise hydrofluoric acid, or for concentrated hydrochloric acid solutions. In particular, this is possible at a temperature >60° C. It is possible here by way of example in the steel-pickling industry, to replace thick-walled polypropylene lines which are usually subject to high levels of wear. This sector cannot use PVC-U, for thermal reasons. Polyvinylidene fluoride cannot generally be used for reasons of cost, and PVC-C also appears to be at least marginal for reasons of cost. The overall effect of the use of the polyvinyl chloride composition is therefore a cost advantage due to easier production, easier processing, and less wear.

Even at high usage temperatures that are not achievable with conventional PVC-U, the polyvinyl chloride composition is particularly resistant to acids, anolyte in chlorine electrolysis, moist chlorine, hypochlorite, salines, aqueous alkalis, and/or concentrated sulfuric acid.

An ideal balance has been achieved between formulation requirements for ensuring good processing, thermoforming, and/or welding and ensuring compatibility with conventional PVC-U, compliance with the quality requirements in accordance with DIN 8061/62 for pipes, and also extension of the usage temperature up to 90° C. and the requirements placed upon the formulation constituents for ensuring best-possible resistance to chemicals within the abovementioned range.

By virtue of the extreme versatility obtained in connection with the PVC composition, it is possible to achieve a marked reduction in the variety of materials conventionally used hitherto in the various application sectors, in particular in the sector of GRP-composite components, and very particularly in the chlorine sector. The PVC composition proposed here can comply with many of the requirements arising. It is therefore amenable to universal use and in particular replaces expensive materials that are complicated to process and that lack stability or are very labile.

Because the PVC composition has lower thermal expansion than polyolefin compositions, it is less susceptible to temperature variations.

Overall, it can be seen that the PVC composition, products comprising same, and also the many different uses of same, contribute to cost reduction and failure avoidance in particular in the chlorine industry and very particularly in the pipeline sector of this industry.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A polyvinyl chloride (PVC) composition, comprising:
a PVC resin of the composition has having a molecular weight distribution with a number average of M_{N}=from 60 kDa to M_{N}=70 kDa and a weight average of M_{W}=from 114 kDa to M_{W}=124 kDa, and wherein:
the chlorine content of the entire composition is from 56% to 62%.

2. The PVC composition as claimed in claim 1, having a Vicat softening point above 90° C.

3. The PVC composition as claimed in claim 1, wherein the composition is free from impact modifiers.

4. The PVC composition as claimed in claim 1, wherein the composition is free from chalk and/or calcium and/or magnesium.

5. The PVC composition as claimed in claim 1, wherein the composition comprises tin and/or a component comprising tin.

6. A pipe, channel, or container for the passage and/or storage of chemically aggressive substances, wherein the pipe, the channel, or the container comprises a PVC composition as claimed in claim 1.

7. The pipe as claimed in claim 6, wherein the pipe is a composite pipe which has an outer wall that comprises glassfiber-reinforced thermoset resin, where the pipe has an inner wall which comprises a PVC composition as claimed in claim 1.

8. The pipe as claimed in claim 7, wherein the inner wall has been bonded to the outer wall via with at least one adhesive resin.

9. The use of a PVC composition as claimed in claim 1 as material resistant to chemicals and to temperature changes for the production of pipes, channels, containers, sheets, moldings, and/or welding rod.

10. The use of a PVC composition as claimed in claim 1 as material resistant to chemicals and to temperature changes for a pipe, a channel, or a container as claimed in claim 6, in particular as an inner wall that is resistant to chemicals, very particularly as liner-composite component.

11. The use of a pipe, of a channel, or of a container as claimed in claim 6 for the passage and/or storage of a chemically aggressive substance which comprises at least one component selected from a group consisting of potassium hydroxide solution or sodium hydroxide solution with ≦50% of KOH or NaOH, potassium chloride solution with ≦350 g/L of KCl, sodium chloride solution with ≦350 g/L of NaCl, hypochlorite with ≦18% of active chlorine, and a concentrated mineral acid, preferably sulfuric acid, hydrochloric acid, nitric acid, or hydrofluoric acid.
